(19) United States
(12) Patent Application Publication
(10) Pub. No.: US 2010/0243125 A1
(43) Pub. Date: Sep. 30, 2010

(54) PROTECTIVE TAPE SEPARATING METHOD AND PROTECTIVE TAPE SEPARATING APPARATUS USING THE SAME

(76) Inventors: Masayuki Yamamoto, Osaka (JP); Masaki Sakata, Kameyama-shi (JP)

Correspondence Address: Cheng Law Group, PLLC, 1100 17th Street, N.W., Suite 503, Washington, DC, 20036, US

(21) Appl. No.: 12/729,323

(22) Filed: Mar. 23, 2010

(30) Foreign Application Priority Data
Mar. 27, 2009 (JP) 2009-078410

(51) Int. Cl. B32B 38/10

(52) U.S. Cl. 156/64; 156/378

(57) ABSTRACT

As a drive block moves that is connected to a movable table of a tape separation device, a pressure occurs from pressing the movable table disposed forward with the drive block. A pressure sensor detects the pressure as a separation load of a protective tape. A control device drives a motor in accordance with the separation load to control a moving speed of the tape separation device.

### BACKGROUND OF THE INVENTION

1. Field of the Invention

This invention relates to a protective tape separating method and protective tape separating apparatus using this method for separating a protective tape together with a separation tape from a surface of a semiconductor wafer by joining the separation tape to the protective tape joined to the surface of the semiconductor wafer having a circuit pattern formed thereon and then separating the separation tape.

2. Description of the Related Art

In performing a back grinding on a rear face of a semiconductor wafer (hereinafter, appropriately referred to as a “wafer”) having a surface with a pattern such as a circuit pattern formed thereon, a protective tape is joined in advance to an entire surface of the wafer. The wafer is ground while being suction-held with a suction-holding member such as a sucking disc on a surface side of the wafer. After the back grinding, the protective tape is separated off from the surface of the wafer through a predetermined process. The wafer is transferred to perform a next dicing process.

JP2004-165570A discloses a conventional and known method of separating off the protective tape from the surface of the wafer as follows. A separation tape having a width smaller than a diameter of the wafer is joined to a protective tape on the wafer. Separating this separation tape leads to separation off of the protective tape together with the separation tape from the surface of the wafer.

When the protective tape is separated from the wafer having a reduced strength due to reduction in thickness of the wafer, the wafer is subject to a separation load resulting from tension at the time of separation. This load will lead to a higher risk of damaging the wafer. As shown in FIG. 1, when the protective tape is separated from one end toward the other end of the wafer at a certain separation speed, a contact area of the protective tape to the wafer increases as the separation proceeds from a separation start end to a central portion of the wafer, whereby the separation load gradually increases. In contrast, the contact area of the protective tape to the wafer decreases as the separation proceeds from the central portion toward a separation termination end of the wafer, whereby the separation load decreases.

Here, a problem may arise from a higher separation speed for improvement of processing efficiency. Specifically, the separation load increases, and separation is to be performed in a critical range where the wafer is likely to be damaged. Moreover, another problem may arise from a lower separation speed for maintaining the separation load value within a safe range as shown by dashed lines in FIG. 1. That is, the lower separation speed may suppress damages of the wafer, but on the other hand, may reduce processing efficiency (tact-time.)

It is also considerable to vary the separation speed into a specific pattern based on a program determined in advance as the separation proceed, thereby maintaining the separation load value within the safe range. However, the protective tape on each wafer has a non-uniform bonding property. Thus, the separation load value may possibly reach the critical range depending to bonding conditions. Therefore, the conventional method is not always a suitable separating method.

### SUMMARY OF THE INVENTION

An object of this invention is to separate a protective tape smoothly with no damage on a wafer while suppressing reduction in processing efficiency when separating the protective tape.

Additional features of the invention will be set forth in the description which follows, and in part will be apparent from the description, or may be learned by practice of the invention.

This invention provides a method of separating a protective tape joined to a surface of a semiconductor wafer together with a separation tape from the surface of the semiconductor wafer by joining the separation tape to the protective tape and then separating the separation tape, including the step of detecting a separation load applied to the protective tape and controlling a separation speed of the protective tape in accordance with detected information on the separation load.

According to the protective tape separating method of this invention, a threshold may be set in advance as a separation load value that allows the protective tape to be safely separated. Where the separation load value detected in separation of the protective tape exceeds this threshold, the separation speed is controlled to decrease to set the separation load value constantly below the threshold for a separation process. Consequently, smooth separation of the protective tape may be realized with no damages on the semiconductor wafer.

Here, with this method, it is preferable to separate the tape while controlling the separation speed such that the separation load value of the protective tape may be maintained at the threshold set in advance.

According to this method, setting of the threshold as much as soon to a high value at which no semiconductor wafer will be damaged may realize a separation with a maintained upper limit speed at which no semiconductor wafer will be damaged. Consequently, the protective tape may be separated efficiently.

The separation load applied to the protective tape is detected as a drive load applied in separation of the protective tape.

Here, where the separation tape is pulled and moved for a separation process, detection of a movement load of a device to pull and move the separation tape leads to easy determination of the separation load. Moreover, where the semiconductor wafer is moved for the separation process without moving the separation tape, detection of the movement load of a separation table with the semiconductor wafer held thereon leads to easy determination of the separation load.

Further, the separation load of the protective tape may be detected as a suction force that varies when the semiconductor wafer suction-held on the separation table floats due to tension in the protective tape in separation of the protective tape.

Here, the semiconductor wafer may be prevented from bending backward and floating from the separation table in separation of the protective tape. Consequently, the semiconductor wafer may be prevented from bending backward and being damaged due to the tension in the protective tape when separating the protective tape. Poor separation of the protective tape may also be suppressed occurring from misalignment of the semiconductor wafer.

This invention also discloses an apparatus configured to separate a protective tape joined to a surface of a semiconductor wafer from the surface of the semiconductor wafer together with a separation tape by joining the separation tape to the protective tape and then separating the separation tape. The apparatus includes the separation table on which the semiconductor wafer with the protective tape joined to the surface thereof is held, a tape separation device to join the separation tape to the surface of the semiconductor wafer held on the separation table along a diameter of the semiconductor wafer, a drive device to move the tape separation device relative to the separation table in a tape separation direction, a detection device to detect a separation load of the protective tape, and a control device to control an operating speed of the drive device in accordance with detection information detected with the detection device.

With this configuration, the above method can suitably be performed.

With the above configuration, the separation load of the protective tape may be detected such that the detection device detects the separation load as a drive load applied to the drive device.

For instance, the detection device may be configured by a detecting roller disposed backward in the tape separation direction of the tape separation device capable of winding up the separation tape and moving upward and downward, and a pressure sensor to detect the separation load of the separation tape from a pressure variation caused by a downward movement of the separation tape that acts on the detecting roller.

According to another embodiment, the separation table may be held along a guide rail so as to move in a horizontal direction. Moreover, the detection device having the separation table disposed backward in the tape separation direction may be a pressure sensor that detects a pressure applied in a movement of the separation table when separating the protecting tape as a separation load.

Furthermore, the detection device may be configured so as to detect the separation load of the protective tape as tension in the separation tape.

With this configuration, a component force of the tension in the separation tape in a perpendicular direction to the surface of the semiconductor wafer corresponds to a separation force (separation load), leading to detection with little disturbance. Consequently, the separation speed may be controlled with high accuracy in accordance with the result detection of the separation load with few errors.

Moreover, the above apparatus may be configured as follows. That is, the separation table has a pressure sensor to detect a suction force when suction-holding the semiconductor wafer. The separation load of the protective tape corresponds to a variation of the suction force detected with the pressure sensor when separating the protective tape. The control device controls an operating speed of the drive device in accordance with the result detection information detected with the pressure sensor.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a characteristic diagram of a separation load value and a separation speed in a conventional tape separating process.

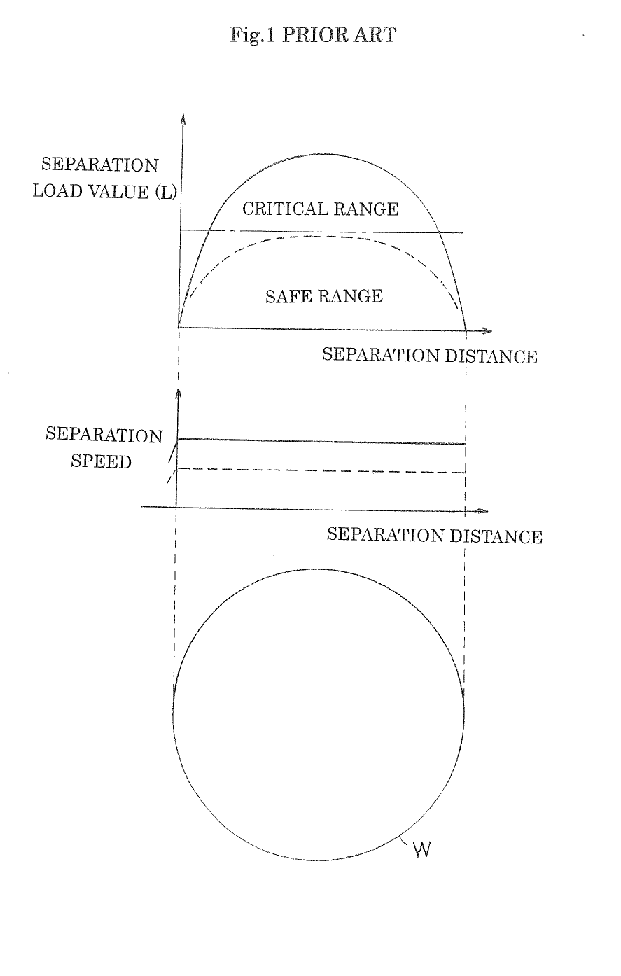

FIG. 2 is a perspective view showing a general configuration of a protective tape separating apparatus.

FIG. 3 is a general elevational view of the protective tape separating apparatus.

FIG. 4 is a general top view of the protective tape separating apparatus.

FIG. 5 is an elevational view showing main components of a tape joining device and a tape separation device.

FIG. 6 is a perspective view showing main components under the tape being separated.

FIGS. 7 to 12 are elevational views each illustrating a tape separation process.

FIG. 13 is a flow chart showing control of separating the tape.

FIG. 14 is a characteristic diagram of a separation load value and a separation speed in separating the tape.

FIG. 15 is an elevational view showing main components of a detection device to detect a separation load according to another exemplary embodiment.

FIG. 16 is an elevational view showing main components of a detection device to detect a separation load according to another exemplary embodiment.

### DESCRIPTION OF THE PREFERRED EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. In the drawings, the size and relative sizes of layers and regions may be exaggerated for clarity. Like reference numerals in the drawings denote like elements.

One exemplary embodiment of this invention will be described in detail hereinafter with reference to the drawings.

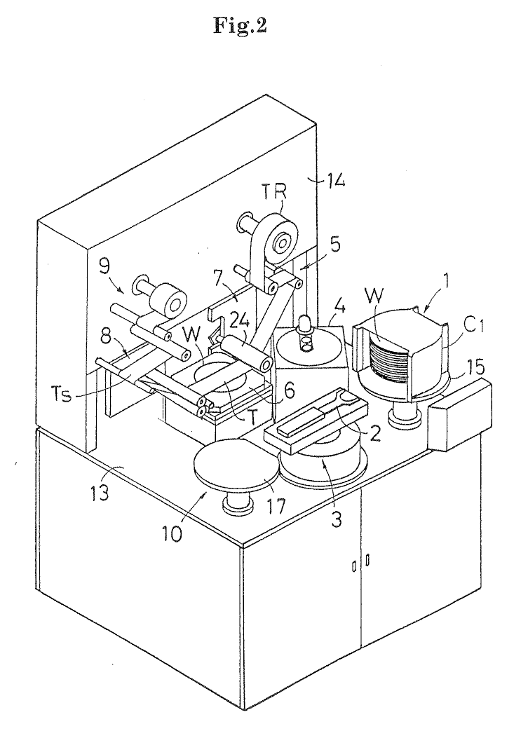

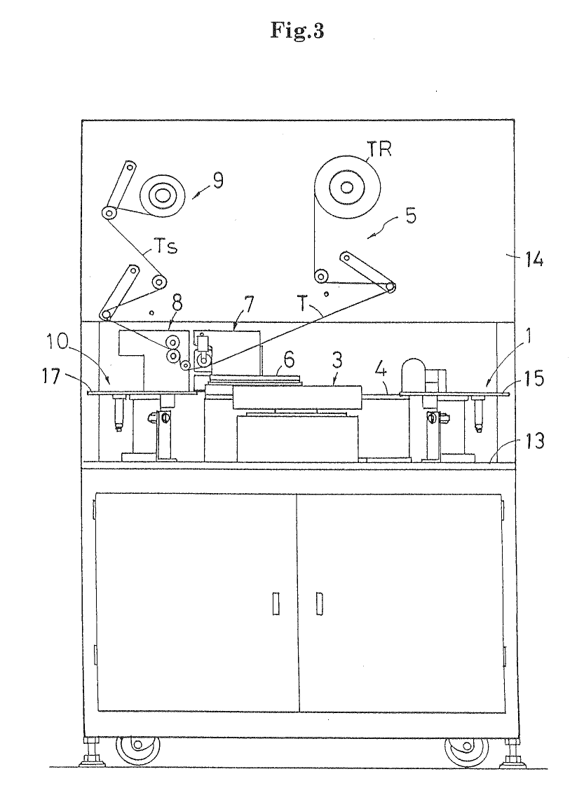

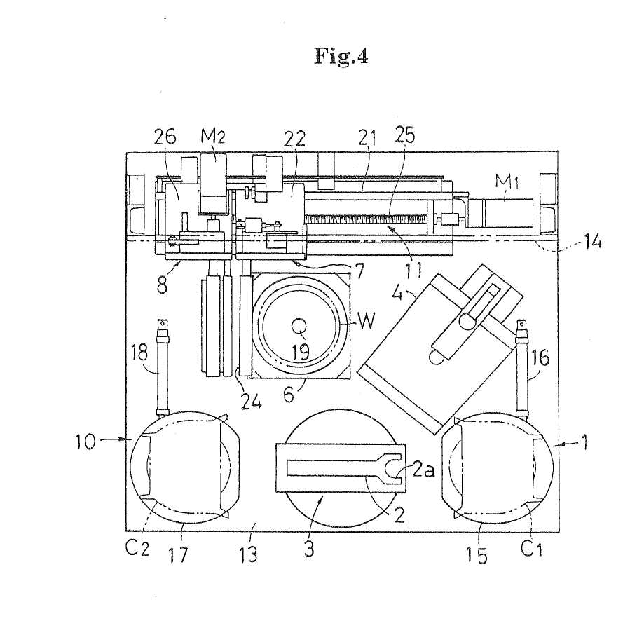

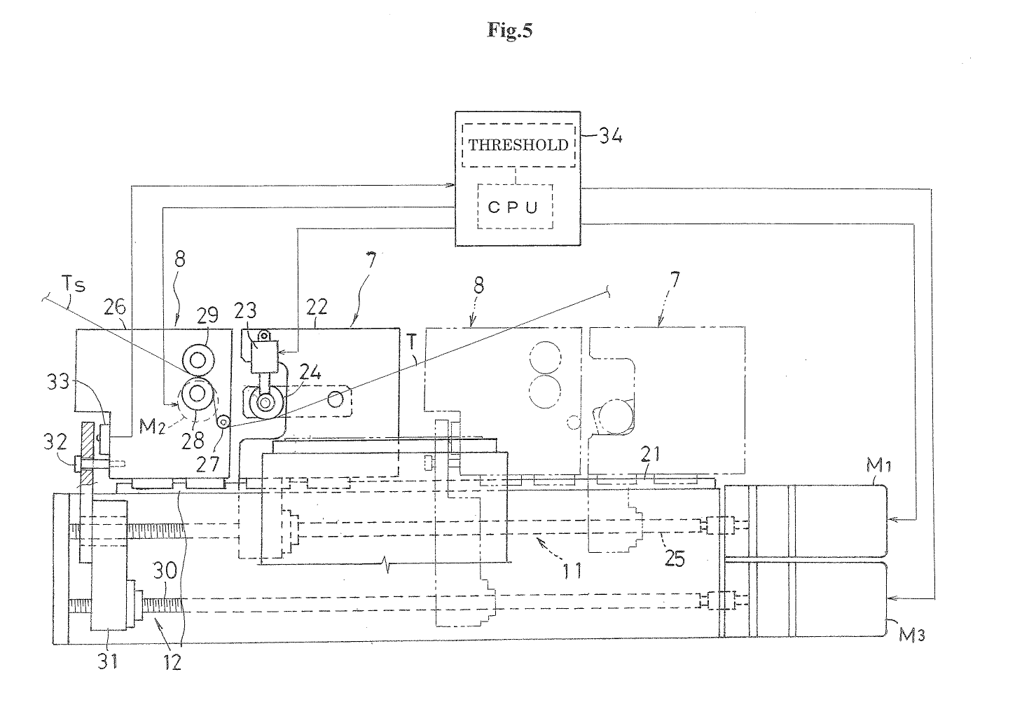

FIG. 2 is a perspective view showing a general configuration of the apparatus to separate the protective tape on the semiconductor wafer, as one example of the apparatus that implements the method of this invention. FIG. 3 is a elevational view of the apparatus, FIG. 4 a plan view thereof, and FIG. 5 an elevational view showing main components thereof.

The protective tape separating apparatus has a wafer supply unit 1, a wafer transport device 3 with a robot arm 2, an alignment stage 4, a tape supply unit 5, a separation table 6, a tape joining device 7, a tape separation device 8, a tape collection unit 9, a wafer collection unit 10, a drive device 11, and a drive device 12 on or above a base 13. The wafer supply unit 1 has a cassette C1 placed therein to receive a semiconductor wafer W (hereinafter, simply referred to as “wafer W”) in a stack manner that is subject to back grinding. The alignment stage aligns the wafer W. The tape supply unit 5 supplies an adhesive tape T for use in separation (hereinafter, referred to as “separation tape T”) to a separating process region. The separation table 6 has the wafer W suction-held thereon. The tape joining device 7 joins the separation tape T to the wafer W on the separation table 6. The tape separation device 8 separates the joined separation tape T. The tape collection unit 9 winds up and collects a separated separation tape Ts. The wafer collection unit 10 has a cassette C2 placed therein to receive the wafer W in a stack manner that is subject to the back grinding. The drive device 11 horizontally reciprocates the tape joining device 7 (see FIG. 5), and the drive device 12 horizontally reciprocates the tape separation device 8.

Here, the wafer supply unit 1, the wafer transport mechanism 3, the alignment stage 4, the separation table 6, and the wafer collection unit 10 are provided on a top face of the base, whereas the tape supply unit 5 and the tape collecting unit 9 on a front face of an upright wall 14 erected from the surface of the base 13. The tape joining device 7 and the tape separation device 8 are arranged in a lower opening of the upright wall 14. The drive devices 11 and 12 are placed at a rear face of the upright wall 14.

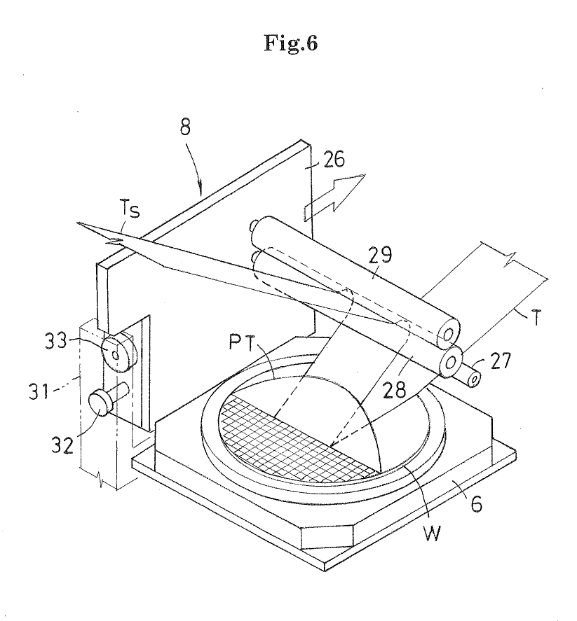

The wafer supply unit 1 has a cassette table 15. The cassette table 15 accommodates the cassette C1 into which the wafer W is inserted at an appropriate vertical distance, the surface of the wafer W with an ultraviolet curable protective tape PT (see FIG. 6) joined thereto being directed upward in a horizontal direction. Moreover, an air cylinder 16 turns the cassette table 15 to vary the direction thereof.

The wafer collection unit 10 also has a cassette table 17. The cassette table 17 accommodates the cassette C2 into which the wafer W with the protective tape being separated therefrom is inserted at an appropriate vertical distance. Moreover, an air cylinder 18 turns the cassette table 17 to vary the direction thereof. Here, the wafer W is subject to an ultraviolet irradiation treatment in advance before the wafer is received in the cassette C2. That is, the tape separation process is performed with reduced adhesion of the protective tape PT to the adhesion layer.

The robot arm 2 of the transport device 3 is capable of moving horizontally, turning, and moving upward and downward. The robot arm 2 has a U-shaped suction holder 2a at a tip thereof. The suction holder 2a pulls out the wafer W from the wafer supply unit 1, supplies the wafer W to the alignment stage 4, transports the wafer W from the alignment stage 4 to the separation table 6, transports the processed wafer W from the separation table 6, and transports the processed wafer W to the wafer collection unit 10.

The tape supply unit 5 guides the separation tape T fed out from a master roll TR through above the separation table 6 to the tape joining device 7 and the tape separation device 8. Here, the separation tape T used has a width smaller than a diameter of the wafer W.

As shown in FIG. 4, the separation table 6 has a surface formed as a vacuum-suction surface for suction-holding the wafer W. The separation table 6 also has a suction pad 19 at a center thereof for delivering the wafer W.

As shown in FIG. 5, the tape joining device 7 has a movable table 22 and a joining roller 24. The movable table 22 is supported so as to horizontally move along a rail 21. The joining roller 24 moves upward and downward with an air cylinder 23. The drive device 11 horizontally moves the tape joining device 7. The drive device 11 reciprocates the movable table 22 at a constant stroke via forward and reverse rotation of a feed screw 25 by a motor M1.

Similarly, the tape separation device 8 has a movable table 26, a guide roller 27, a feed roller 28, and a holding roller 29. The movable table 26 is supported so as to horizontally move along the rail 21. The feed roller 28 is driven to rotate by a motor M2. The holding roller 29 faces toward the feed roller 28. The drive device 12 horizontally moves the tape separation device 8. In the drive device 12, a drive block 31 is screwed to a feed screw 30 that performs forward and reverse drive with a motor M3. Specifically, a drive pin 32 with a head connects the movable table 26 to the drive block 31 that is horizontally screwed via forward and reverse rotation of the feed screw 30 so as to provide an interlock therebetween.

The drive pin 32 with the head is slidably inserted into one surface of the drive block 31, and is connected to a back end of the movable table 26. A pressure sensor 33 such as a load cell is provided on the back end of the movable table 26 so as to be close to a front face of the drive block 31. When the drive block 31 moves forward (i.e., to the right side in FIG. 5), the movable table 26 is pushed to move forward via the pressure sensor 33, whereas when the drive block 31 moves backward (i.e., to the left side in FIG. 5), the table 26 is drawn back via the drive pin 32.

According to the above configuration, the pressure sensor 33 detects only a drive load applied to the movable table 26 in a forward movement of the drive block 31 during reciprocation thereof. The pressure sensor 33 may be used as a detection device to detect a separation force. The pressure sensor 33 as the detection device is connected to a micro-computing control device 34 to control operations of the motors M1, M2, and M3. Description will be made hereinafter of controlling the separation force in the protective tape with the detection device.

Next, with reference to FIGS. 6 to 12, description will be made of an essential process to separate the protective tape PT joined to the surface of the wafer W using the protective tape separating apparatus.

First, as shown in FIG. 2, the robot arm 2 moves into the cassette C1 in the wafer supply unit 1. Subsequently, the robot arm 2 suction-holds a specified wafer W on a rear face thereof, pulls out the wafer W, and moves to place the wafer W on the alignment stage 4. The alignment stage 4 performs alignment of the wafer W placed thereon, through use of a notch formed in advance at the outer periphery of the wafer W. The robot arm 2 then holds an underside (the rear face) of the aligned wafer W, transfers the wafer W from the alignment stage 4 to supply the wafer W above the separation table 6.

The suction pad 19 projecting from the table receives the transferred wafer W above the separation table 6, and then places the wafer W on the upper face of the separation table 6 in a predetermined attitude and position while moving downward.

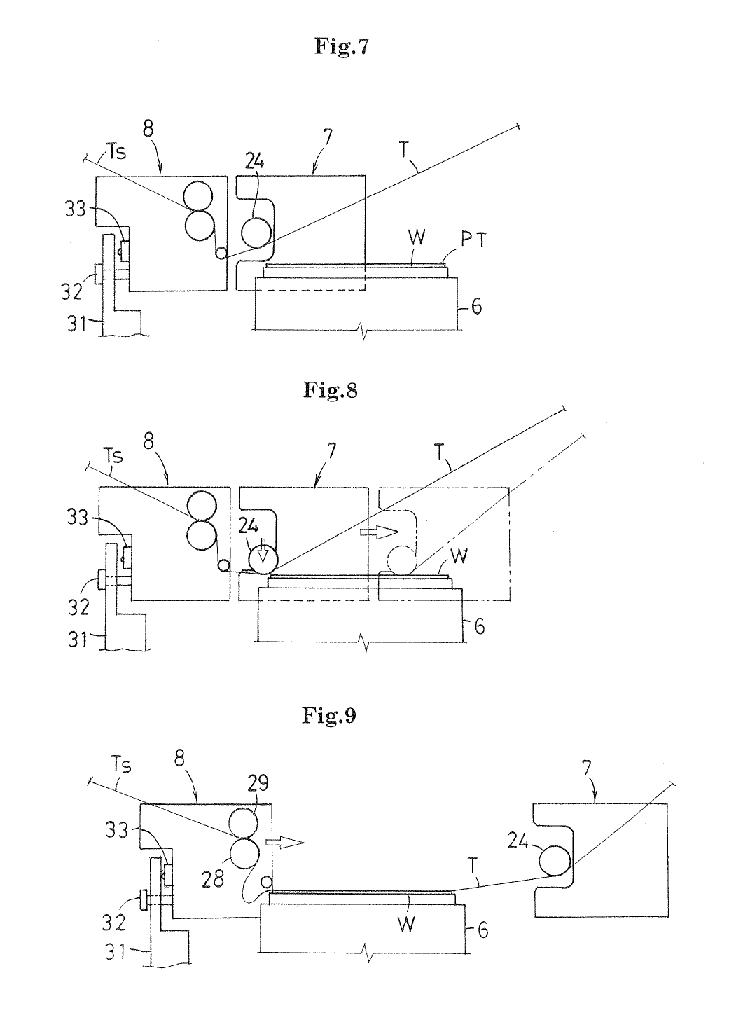

In a state where the wafer is loaded above the separation table 6, as shown in FIG. 7, the tape joining unit 7 and tape separation unit 8 are in a standby position on the rear side of the separation table (on the right side of FIG. 7.)

When the wafer W is placed on the separation table 6, as shown in FIG. 8, the joining roller 24 of the tape joining device 7 moves downward to a predetermined joining level. Subsequently, the joining roller 24 joins the separation tape T to the surface of the protective tape PT (see FIG. 6) while rolling over the upper face of the wafer W as the tape joining device 7 moves forward.

After joining of the separation tape T is completed, the tape separation device 8 moves forward with rotation of the feed roller 28 being fixed, as shown in FIG. 9. As the tape separation device 8 moves forward by a predetermined distance, tension starts to be applied on the separation tape T out of a wafer edge in a backward side.

As the tape separation device 8 further moves forward, the separation tape with the protective tape PT integrally joined thereto is rolled up from the wafer edge, as shown in FIGS. 6 and 11. The protective tape PT is gradually separated from the surface of the wafer as the tape separation device 8 moves forward.

When the protective tape PT is completely separated, the suction pad 19 (see FIG. 4) once lifts up the wafer W. Subsequently, the robot arm 2 shown in FIG. 2 suction-holds the rear face of the wafer W, and transfers the wafer W from the separation table 6. The robot arm inserts and accommodates the wafer W into the cassette C2 in the wafer collection unit 10. Then, the tape joining device 7 and tape separation device 8 move backward to return to an original standby position. Simultaneously, the tape collecting section 9 rolls up the separation tape and the feed roller 28 performs feeding. In such a way, the separation tapes Ts separated may be rolled up and collected.

Thus, one tape joining process is completed as described above, and the apparatus is set to be in a standby state for receiving a next wafer.

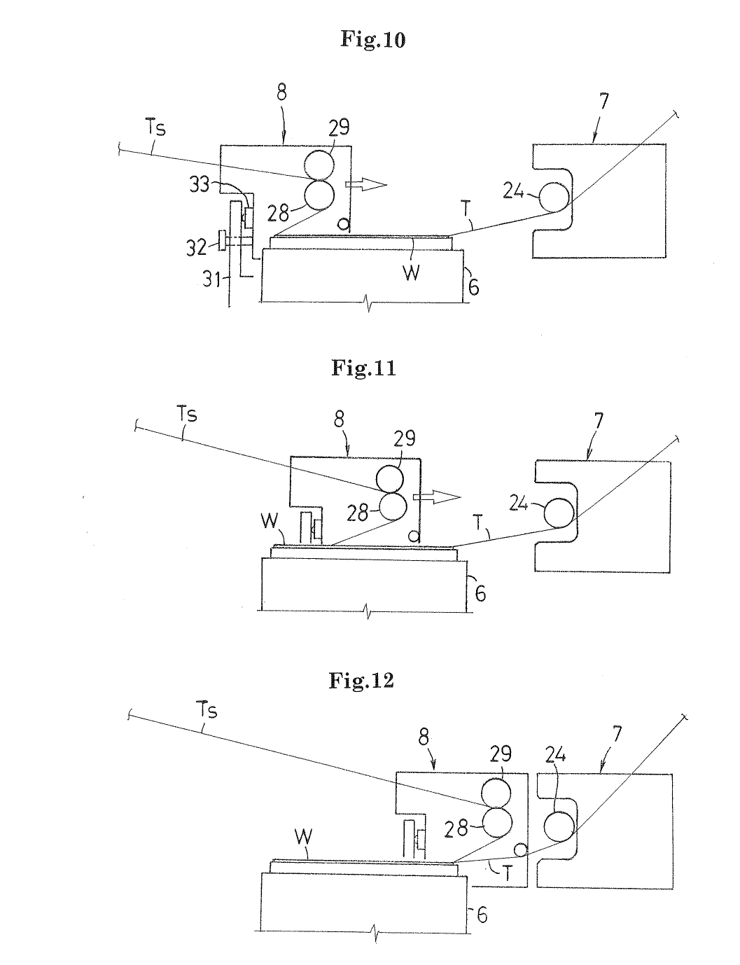

In the tape separating process mentioned above, the movement speed (separation speed) of the tape separation device 8 in a forward direction is controlled in accordance with detection information detected with the pressure sensor (detection device) 33. The control will be described with reference to the flowchart of FIG. 13.

Specifically, when the command is issued to control the tape separation, the pressure sensor 33 initiates detection of the separation load value L (STEP S01), and the tape separation device 8 initiates moving (STEP S02.) Herein, during an initial period before the tape is separated by a predetermined distance, a movement speed (separation speed) of the tape separation device 8 is controlled (control of the initial speed is performed) depending on characteristics of the separation tape programmed in advance (STEP S03.)

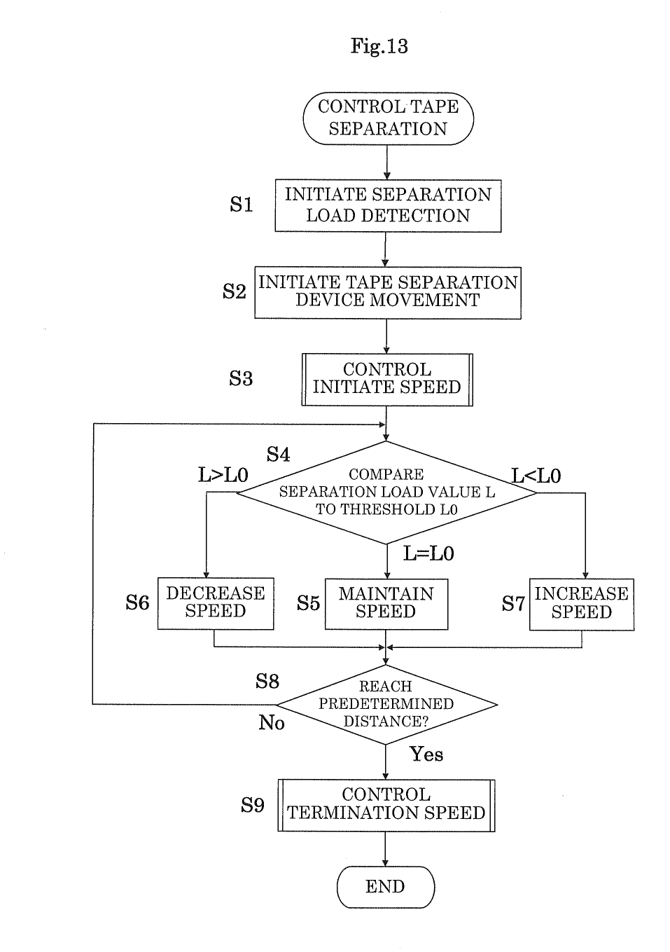

Specifically, the initial speed is controlled so as to accelerate gradually from when the tape separation device 8 initiates moving in a standby position, as shown in FIG. 7, until when the separation tape T bends backward such that the tension is applied thereon, as shown in FIG. 10. Thus, as shown in FIG. 14, the separation speed reaches the upper limit set in advance when the separation starting point in the separation tape reaches the wafer edge, whereby rapid formation may be made of the separation starting point at the wafer edge. Here, a smaller contact area of the protective tape PT to the wafer in the vicinity of the wafer edge results in easy separation of the protective tape. Thus, as shown in FIG. 14, the separation speed is preferably controlled so as to decrease once to prevent the unnecessary separation load value L from being applied to the wafer W. In this way, control of the initial speed leads to reliable and smooth initiation of separating the separation tape T.

When the control of the initial speed is completed, a CPU of the control device 34 performs the comparison operation process to the separation load value L detected with the pressure sensor 33 and the threshold L0 inputted and set in advance (STEP S04.) Herein, the threshold L0 is set to a value slightly lower than a lower limit of a critical range (i.e., an upper limit of a safe range) where the wafer is likely to be damaged. The threshold L0 may be properly modified depending on a type of the protective tape PT or separation tape T to be used, a diameter or thickness of the wafer W, and the like.

Where the separation load value L is equal to the threshold L0 (including a dead zone), the separation speed is maintained in a present state (STEP S05.) Where the separation load value L is higher than the threshold L0 (including the dead zone), the separation speed is controlled to decrease (STEP S06.) In addition, where the separation load value L is lower than the threshold L0 (including the dead zone), the separation speed is controlled to increase (STEP S07). Since the separation speed is controlled in accordance with variation of the separation load value L at every time for the separation, tape separation proceeds while separation stress that is applied from the initiation to the termination of separating the protective tape PT is stably maintained around the threshold L0.

A separation distance is measured by detecting rotation of proper means such as the motor M3 using a rotary encoder. Moreover, it is determined whether or not the tape separation has reached the wafer edge on a terminal end side thereof over the wafer center (STEP S08.) When the tape separation device 8 reaches the wafer edge on the terminal end side, the movement speed (separation speed) thereof is controlled to decrease (control of the terminal speed is performed) depending on characteristics of the separation tape programmed in advance (STEP S09.)

Where the separation load value L increases rapidly at more than an acceleration set in advance, or reaches and exceeds the critical range, this apparatus is desirably configured to stop the forward movement of the tape separation device 8 while raising an alarm.

According to the apparatus in the exemplary embodiment described above, the movement speed of the tape separation device 8 is controlled so as to apply to the protective tape PT the separation load value within the safe range that is close to the upper limit before the critical range in which the wafer is likely to be damaged. Consequently, the protective tape PT may be separated from the surface of the wafer W together with the separation tape T by separation of this separation tape with no wafer W being damaged. That is, the tape separation device 8 may move at a movement speed not more than the upper limit in which no wafer W is likely to be damaged.

The exemplary embodiment of this invention may be modified in the following forms.

In the exemplary embodiment described above, the rotation load of the feed screw 30 may be detected with a torque sensor. That is, the torque sensor may detect the drive load of the tape separation device 8, and the separation load value L may be calculated based on the result drive load.

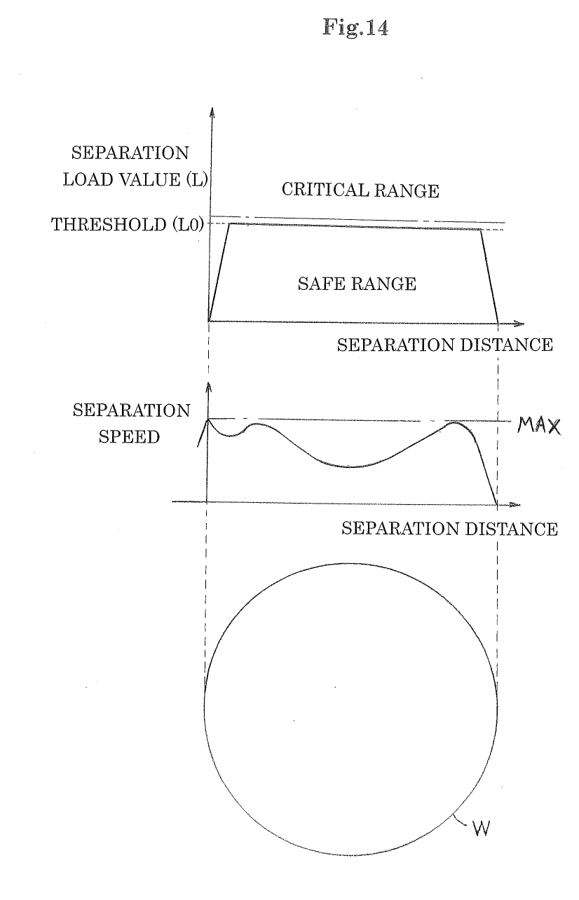

As shown in FIG. 15, the detection device may be configured by the detecting roller 35 and the pressure sensor 33. The detecting roller 35 is disposed backward in a tape separation direction of the tape separation device 8 capable of winding up the separation tape and moving upward and downward. The pressure sensor 33 detects the downward movement of the separation tape that acts on the detecting roller 35 by converting it into a pressure. With this configuration, the movement force and tension that applied to the separation tape T may also be used as the separation load value L based on correlation data correlated with each other in advance.

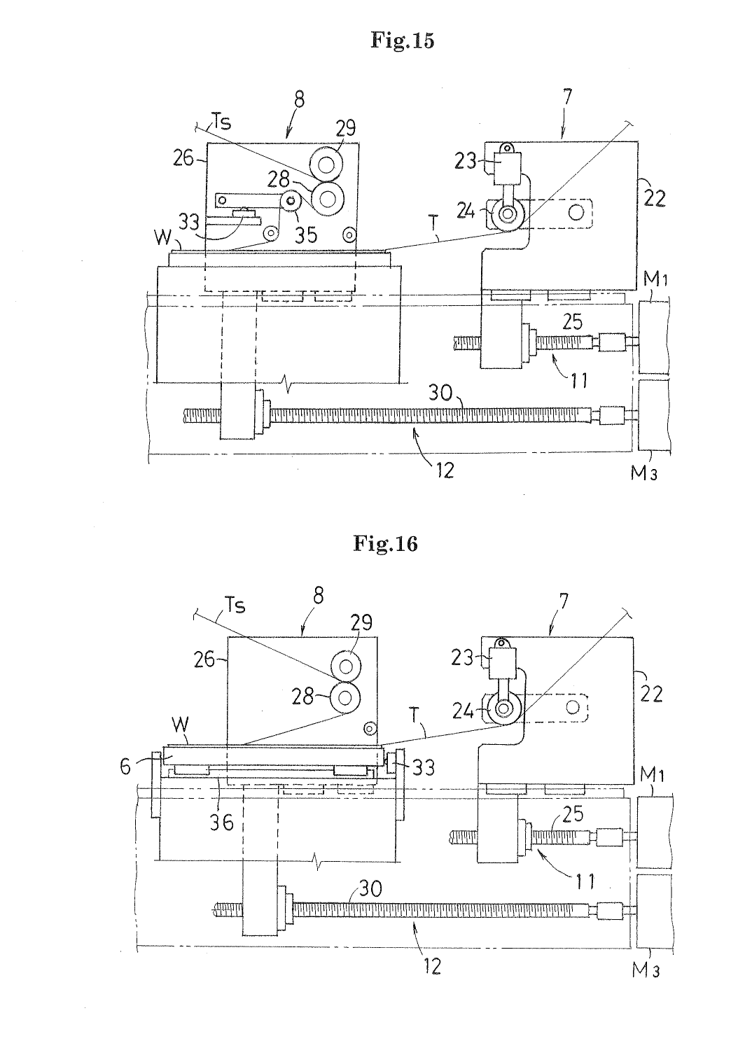

As shown in FIG. 16, the separation table 6 may be supported along the guide rail 36 so as to move in a horizontal direction, and the pressure sensors 33 such as a load cell may be fixed that receives the separation table 6 backward in the tape separation direction (in the right side of FIG. 16.) With this configuration, the separation load value L may also be calculated by detecting the pressure with the pressure sensor 33 that acts on the separation tape T in a horizontal direction relative to the tension of the separation tape T.

In the exemplary embodiment mentioned above, the tape separation device 8 may move. The tape separation device 8 may be fixed, and the separation table 6 may perform separation so as to move in a horizontal direction.

In the exemplary embodiment mentioned above, the pressure sensor 33 may detect the load applied when the tape separation device 8 or separation table 6 moves. The following configuration may also be made.

The movement speed of the tape separation device 8 or separation table 6 may be controlled based on variation of the suction force of the wafer W applied by the separation table 6.

For instance, the tape separation device 8 moves, and simultaneously the pressure sensor detects the suction force of the wafer W applied by the separation table 6 in real time. Where a suction force decreases during the detection process, the movement speed of a moving object such as the separation device 8 decreases until the suction force is maintained constant.

Specifically, where a separation load becomes higher than the suction force of the wafer W applied by the separation table 6 and the wafer W bends backward and floats from the separation table 6, the movement speed of the moving object such as the tape separation device 8 decreases. With this configuration, the wafer W fails to be damaged due to the separation load. The exemplary apparatus mentioned above may also have this configuration.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

What is claimed is:

1. A method of separating a protective tape joined to a surface of a semiconductor wafer together with a separation tape from the surface of the semiconductor wafer by joining the separation tape to the protective tape and then separating the separation tape, comprising:
detecting a separation load applied to the protective tape and controlling a separation speed of the protective tape in accordance with detected information on the separation load.

2. The method of separating the protective tape according to claim 1, wherein
separating of the protective tape is performed while controlling the separation speed such that the separation load value of the protective tape is maintained at a threshold set in advance.

3. The method of separating the protective tape according to claim 1, wherein
the separation load applied to the protective tape is detected as a drive load applied in separation of the protective tape.

4. The method of separating the protective tape according to claim 3, wherein
the drive load is detected as a pressure to a movable table that is detected in a forward movement of a drive block included in a tape separation device connected via a drive pin that is slidably inserted into the drive block in a backward side.

5. The method of separating the protective tape according to claim 3, wherein
the drive load is detected as a torque variation applied to a drive device when the tape separation device operates.

6. The method of separating the protective tape according to claim 1, wherein
the separation load is detected as a pressure variation caused by a downward movement of the separation tape that acts on a detecting roller disposed backward in a tape separation direction of the tape separation device capable of winding up the separation tape and moving upward and downward.

7. The method of separating the protective tape according to claim 1, wherein
the separation table with the semiconductor wafer being held thereon is supported along a guide rail so as to move in a horizontal direction; and
the pressure sensor that receives the separation table backward in the tape separation direction detects the separation load as a pressure applied in a movement of the separation table when separating the protecting tape.

8. The method of separating the protective tape according to claim 1, wherein
the separation load of the protective tape is detected as a suction force that varies when the semiconductor wafer suction-held on the separation table floats due to tension in the protective tape in separation of the protective tape.

9. An apparatus for separating a protective tape joined to a surface of a semiconductor wafer from the surface of the semiconductor wafer together with a separation tape by joining the separation tape to the protective tape and then separating the separation tape, comprising:
a separation table on which the semiconductor wafer with the protective tape joined to the surface thereof is held;
a tape separation device to join the separation tape to the surface of the semiconductor wafer held on the separation table along a diameter of the semiconductor wafer;
a drive device to move the tape separation device relative to the separation table in a tape separation direction;
a detection device to detect a separation load of the protective tape; and
a control device to control an operating speed of the drive device in accordance with detection information detected with the detection device.

10. The apparatus for separating the protective tape according to claim 9, wherein
the detection device detects the separation load of the protective tape as a drive load applied to the drive device.

11. The apparatus for separating the protective tape according to claim 9, wherein
the detection device detects the separation load of the protective tape as tension in the separation tape.

12. The apparatus for separating the protective tape according to claim 9, wherein
the tape separation device includes a drive block so as to reciprocate by a drive device, and a movable table connected via a drive pin that is slidably inserted into the drive block in a backward side, the detection device being a sensor to detect a pressure to the movable table occurring in a forward movement of the drive block.

13. The apparatus for separating the protective tape according to claim 9, wherein
the detection device is configured by a detecting roller disposed backward in the tape separation direction of the tape separation device capable of winding up the separation tape and moving upward and downward, and a pressure sensor to detect the separation load of the separation tape from a pressure variation caused by a downward movement of the separation tape that acts on the detecting roller.

14. The apparatus for separating the protective tape according to claim 9, wherein
the separation table is held along a guide rail so as to move in a horizontal direction, and the detection device having the separation table disposed backward in the tape separation direction is a pressure sensor that detects a pressure applied in a movement of the separation table when separating the protecting tape as the separation load.

15. The apparatus for separating the protective tape according to claim 9, wherein
the separation table has a pressure sensor to detect a suction force when suction-holding the semiconductor wafer, the separation load of the protective tape corresponds to a variation of the suction force detected with the pressure sensor when separating the protective tape, and the control device controls an operating speed of the drive device in accordance with the result detection information detected with the pressure sensor.
